(19) United States
(12) Patent Application Publication
(10) Pub. No.: US 2014/0189835 A1
(43) Pub. Date: Jul. 3, 2014

(54) SYSTEMS AND METHODS FOR EFFICIENT AUTHENTICATION OF USERS

(71) Applicant: PITNEY BOWES INC., Stamford, CT (US)

(72) Inventor: Raymond Umerley, Wilton, CT (US)

(73) Assignee: PITNEY BOWES INC., Stamford, CT (US)

(21) Appl. No.: 13/729,674

(22) Filed: Dec. 28, 2012

(51) Int. Cl. G06F 21/40

(52) U.S. Cl. CPC G06F 21/40
USPC 726/7

(57) ABSTRACT

Systems and methods for efficient user authentication in a client-server system using a tiered, risk-based approach including a no-risk tier are provided. When a user requests access to the system for a no-risk feature, the user is registered without an additional authentication test. When the user later requests a higher risk transaction, the user is provided with the appropriate third-party additional authentication test based upon the risk level and applicable vendor profile. During no-risk access to the system, user data is collected that may be used with the additional authentication test at the appropriate time.

### TECHNICAL FIELD

The illustrative embodiments of the present application relate generally to user authentication in document delivery systems and, more particularly, to new and useful systems and methods for efficient authentication using a tiered, risk-based approach including a no-risk tier.

### BACKGROUND

In the United States, many people are utilizing electronic access to financial and other transactional accounts including banking, credit and utility accounts. Additionally, there has been significant adoption of electronic bill payment in recent years, with electronic payment now outpacing payment by putting a check in the mail. Systems that process sensitive financial and transactional accounts typically employ expensive and advanced security techniques. Such systems consider every user to require a relatively high level of security and employ a relatively secure level of user authentication for account initiation and access.

However, such authentication systems are expensive and do not provide a low cost option that can be used with no risk users. For example, systems and methods have been described that utilize varied levels of an expensive authentication system based upon a risk level associated with a transaction. In, U.S. Pat. No. 8,239,677 B2, entitled verification and authentication systems and methods, issued Aug. 7, 2012 to Colson describes a system that uses a two-question authentication quiz for transactions valued at US$1 and a six-question authentication quiz for transactions valued at over US$100,000. However, such systems require the use of some level of the expensive authentication quiz scheme for even the lowest risk transaction valued at US1$.

Accordingly, there is a need, among other needs in the field, for systems and methods that provide more efficient and cost effective authentication of users in a system that has at least two different risk levels.

### SUMMARY

Illustrative systems and methods for providing efficient user authentication are described herein. In certain embodiments, systems and methods for efficient user authentication in a client-server system use a tiered, risk-based approach including a lowest or no-risk tier.

In certain embodiments, when a user requests a new registration and access to the system for a no-risk feature, the user is registered without an additional authentication test. When the user later requests a higher risk transaction, the user is provided with the appropriate third-party additional authentication test based upon the risk level and applicable vendor profile. During no-risk access to the system, user data is collected that may be used with the additional authentication test at the appropriate time.

In certain embodiments, the system provides one or more vendors with a risk profile capability so that the vendors may set risk profiles including transaction types and associated authentication tests.

Several additional alternatives are disclosed and described herein.

### BRIEF DESCRIPTION OF THE DRAWINGS

The accompanying drawings show illustrative embodiments of the invention and, together with the general description given above and the detailed description given below serve to explain certain principles of the invention. As shown throughout the drawings, like reference numerals designate like or corresponding parts.

FIG. 1 is a schematic diagram showing a system for providing efficient user authentication according to an illustrative embodiment of the present application.

FIG. 2 is a flowchart diagram showing a process for providing efficient user authentication according to an illustrative embodiment of the present application.

FIG. 3 is a flowchart diagram showing a process for providing efficient user authentication according to an illustrative embodiment of the present application.

FIG. 4 is a flowchart diagram showing a process for providing efficient user authentication according to an illustrative embodiment of the present application.

FIG. 5 is a flowchart diagram showing a process for providing efficient user authentication according to an illustrative embodiment of the present application.

### DETAILED DESCRIPTION

The illustrative embodiments described herein are presented from the perspective of a client-server based system that supports a plurality of users and access to content associated with a plurality of vendors. For example, the systems provide efficient and timely new user registration in an electronic digital mailbox system. Here the system may provide its users with access to mail and other features such as payment for a variety of vendors such as government agencies and financial institutions. Similarly, the system may provide access to vendors who provide less sensitive information such as coupons and other non-sensitive features.

In certain embodiments, a user of the system may receive only low or no risk information such as non-confidential government notices and promotional communications. Other users may receive medium risk mail, while others may receive high risk mail. Additionally, the user's needs and category of use of the system may change over time. The various levels of risk are described herein and may be measured in terms of known risk factors including privacy issues, commercial sensitivity, a level of risk of monetary fraud, or some combination.

There are several concerns with identity verification systems that are used with remote access client-server computing systems such as those that handle banking and other financial information. By way of description, Identity verification in such a system may include the identity proofing component of obtaining the facts associated with a account owner that are proof of identity and then an identity authentication process to obtain a certain level of assurance that the present user is indeed that person. In such electronic systems, these transactions are handled remotely and there is no bank teller or other clerk involved in the process to manually inspect identity documents in order to manually verify identity for a transaction. Accordingly, there may be concerns regarding illicit access to the system. However, methods to combat such risk typically add significant cost and delay to the system and are detrimental to the overall user experience. Accordingly, one of the features of the new systems described herein is that they strike a better balance than previous systems in providing security while minimizing cost and reducing and negative impact on the user's experience.

In at least certain embodiments herein, an identity verification system combines verified public, private and proprietary identity proofing data sources with a tiered, risk-based authentication technology. It is believed that at least one benefit to such systems is providing transparent risk assessment that increases security without sacrificing consumer usability.

In a client-server system, certain identification information may be offered by a user to establish a user profile and identity during a registration process. At that time, a user name and password or other login credentials may be assigned and associated with the account based upon provided identification information such as that shown in TABLE 1 below. Unfortunately, identification information may be known to third parties who may wish to impersonate a user.

TABLE 1
ID Proofing

Names and aliases
Address History
Telephone History
Associates and relatives
AGE and Date of Birth
Domain associations
Professional Licenses
Drivers Licenses
Property Records
Vehicle Registrations
Voter Registrations
SSDI
OFAC

Accordingly, in certain situations, additional authentication tests may be used. User authentication systems are required and exist today including those that make use of knowledge based questionnaires to authenticate users. However, such systems often apply complicated questionnaires in all user interaction scenarios. For example, third party authentication systems are available from Acxiom Corp., of Little Rock, Ark. and Experian Information Solutions, Inc. of Costa Mesa, Calif. Alternatively, EXPERIAN TRUEVUE is a Customer Data Integration (CDI) solution that may be used. There are several types of forms that additional authentication tests can take including knowledge based questions and even so called “out-of-wallet” questionnaires that may be more expensive and more likely to be accurate. Many issues arise in authenticating a remote computer user and several factors may be of concern. Several issues are shown below in TABLE 2.

TABLE 2
Authentication Issues

What is the User trying to do?
What is the Risk of the transaction?
Who is the User?
What Device is the User using
Where is the User access the system from?
Is this Normal Behavior based on User history?

Certain illustrative embodiments of this application provide a sub-process that is used for low-risk transactions whereby a user is provided limited authorization based upon a no-cost or low-cost authentication process. If such a user later requests a higher risk transaction, a more robust, albeit slower and costlier, authentication process is applied. The system provides a risk-based user authentication scheme that provides for faster, more efficient and more economical user authentication that provides a better customer experience. In one sub-process for processing a low-risk transaction, a new user is permitted to obtain a limited account without passing any level of a knowledge based questionnaire that is used for higher risk transactions. The system maintains the limited account status until the user requests a higher level transaction. At that time, a higher strength authentication process is used such as a knowledge based questionnaire that has a strength selected in accordance with the risk profile. Such a system is faster, cheaper and provides a better customer experience compared to other risk based authentication schemes. It provides a hyper-efficient, speedy authentication process used for low risk transactions that bypasses the knowledge based questionnaire.

At a high level, a risk based approach to identity verification. This means that the level of verification that a consumer is subjected to is based on the type of transaction they are attempting to perform in the system such as the VOLLY digital mailbox system from Pitney Bowes, Inc. of Stamford, Conn. Several illustrative embodiments described herein refer interchangeably to the VOLLY system or a digital mailbox system (DMB). The illustrative system provides a secure digital mailbox system servicing users and many vendors (mailers) that also utilizes third-party authentication servers efficiently. Some sensitive mail types may include transaction statements, such as from financial institutions. Some non-sensitive mail types may include government notices, marketing promotions, catalogs and other rich media from businesses to consumers.

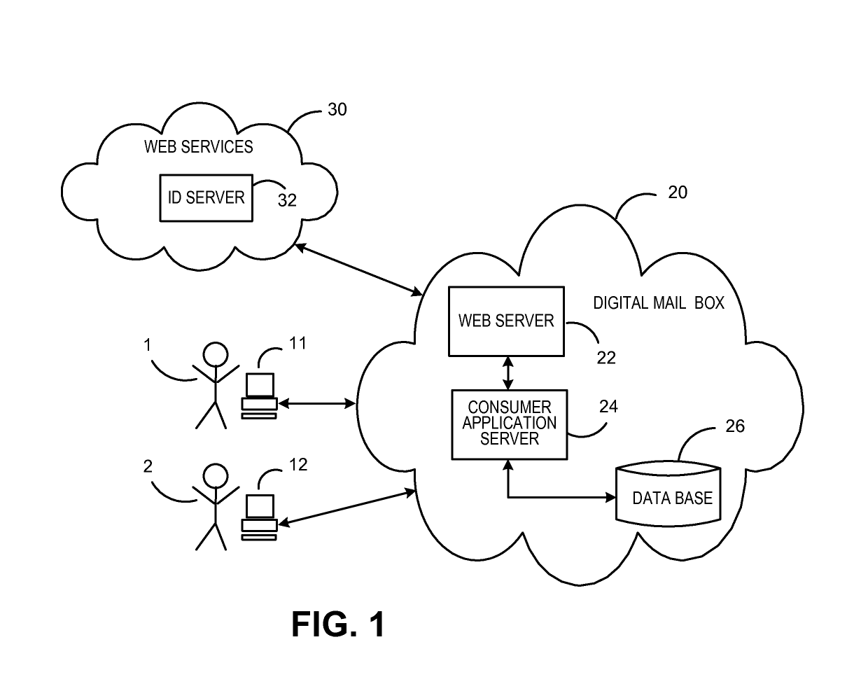

Referring to FIG. 1, a schematic diagram of a system for providing efficient user authentication according to an illustrative embodiment of the present application is shown. The many users of the system are represented by a first user 1 and a second user 2. The first user has a first user device 11 that can utilize many technologies. For example, first user device 11 may be a smart phone, cell phone, PDA, laptop, netbook, notebook, tablet, PC or any other user computing device that can perform the functions described herein. Second user device 12 may use the same or similar client technologies to interact with the remote server digital mailbox 20. The electronic communications may be through the Internet or other connection or network such as point-to-point, Local Area Network (LAN) or Wide Area Network (WAN). The communications channels may be secured as desired such as by using encryption.

The digital mailbox system 20 may be implemented using one or more alternative computing architectures. For example, the system may be implemented on a cloud based platform using Infrastructure as s Service (IaaS) architecture for processing and storage such as the RACKSPACE CLOUD, and TERREMARK ECLOUD platform, the MICROSOFT AZURE platform or the AMAZON EC2 platform. Alternatively, the systems, processes and storage functions described may be implemented using other hosting architectures such as in-house, dedicated hosting, shared hosting or some other hosting model. The Web Server 22 may utilize the APACHE system web server. The Consumer Application Server 24 may use the TOMCAT system and may be used to execute al of the business rules and logic described herein. The attached Database 26 may utilize the CASANDRA system and may be used to store the data described herein including user profiles and vendor profiles. The Consumer Application Server may also perform functions such as using an SMTP server to send email authentication messages to user and to evaluate associated replies.

Similarly, the third-party identity information service provider system 30 may be based upon any of the above mentioned architectures. Here, the ID server 32 may provide the knowledge-based and out-of-wallet questionnaires as described herein for use in authenticating users. The systems may be run by AXCIOM or EXPERIAN as described herein. The ID Server 32 may be used with system 30 using Web Services and an Application Program Interface (API) for providing the interchange with the DMB system including receiving identity date, sending a requested authentication questionnaire, receiving answers from the user and scoring those answers. The data provided to the third-party may include, but is not limited to, one or more of the user Full Name, Address, email address and mobile telephone number.

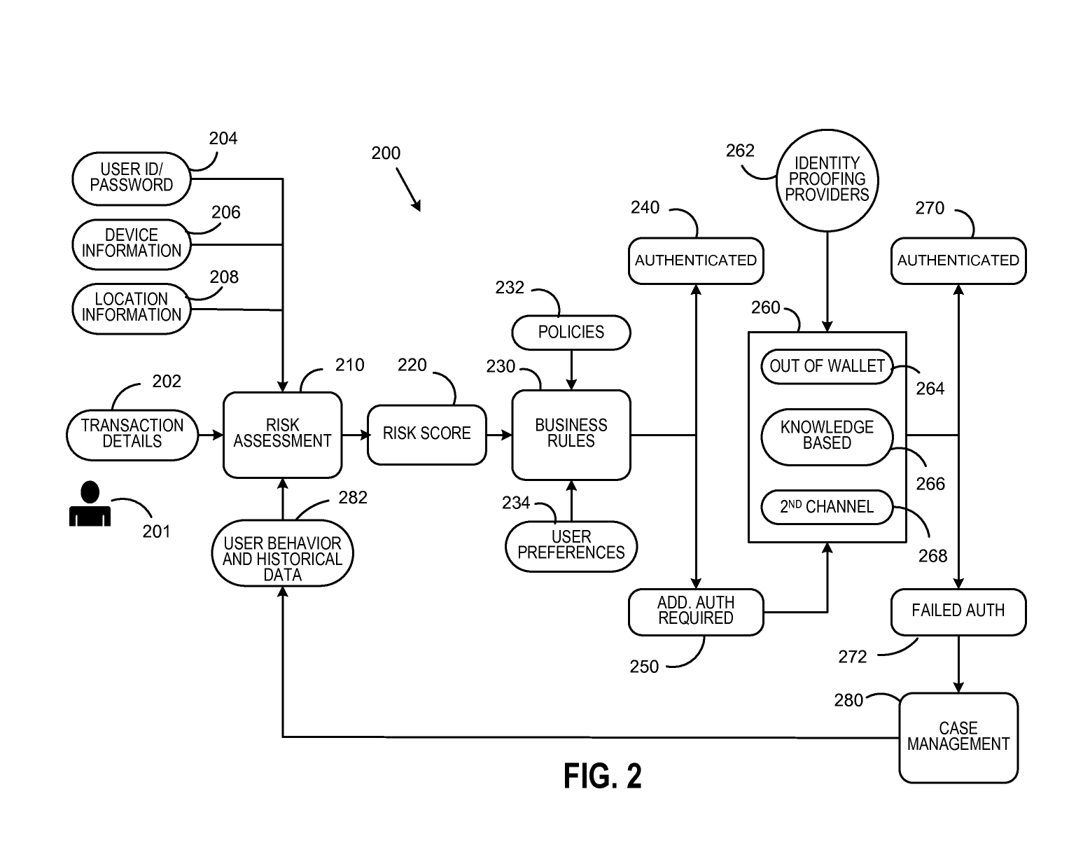

Referring to FIG. 2, a flowchart diagram of a process 200 for providing efficient user authentication according to an illustrative embodiment of the present application is shown. Here, User 201 requests to process a transaction of a transaction type. The transaction details may include, and as with other places herein, are not limited to a registration transaction, an add provider transaction and a payment transaction. The user 201 may provide one or more of a user id/password 204, device information 206 and location information 206, manually or automatically to the system to provide a risk assessment in 210. Here, risk assessment 210 may use feedback for an existing user 201, if available, in the form of user behavior and historical data 282.

In step 210, a risk score is determined and may be a numeric value or other range value such as no-risk, low, medium, or high risk. For example, historical and user behavior data such as access from an unusual location or use in an unusual way may increase the risk score. In step 230, business rules are applied to determine further processing. Here, the business rules may include a default for the system for one or more types of transactions and may include certain minimum or replacement rules and associated data saved by vendor. Here, policies 232 may include digital mailbox system policies and may include vendor (mailer) policies. Furthermore, user preferences 234 may be utilized. The policies applied may be global, regional, by service bureau, by brand, by vendor or even by subgroup such as by line of business for a vendor.

In certain cases, where there is no-risk, or in some cases an equivalent low risk determination, the user is authenticated without any further additional authentication required in step 240. For example, a new user wishing to register who does not require access to sensitive information such as material from a financial company is provided immediate authentication and registration. Similarly, in certain situations, previous authentication for an above no-risk level can be applied if at least at the requested level and will suffice such that authentication is immediately applied in step 240. In another case, a previous authentication at a higher than currently requested level may be required to permit immediate authentication, such as by requiring one higher level. In each case, this results in an efficient authentication that does not incur third party authentication charges and that provides a faster, better user experience.

If it is determined that additional authentication is required in step 250, then one or more processes 260 may be utilized. The system may access one or more identity proofing providers 262 to facilitate the processes in step 260. One or more of the processes may be indicated depending on the business rules and the transaction details. In fact, various levels of the various processes may be used. For example, a second channel verification 268 may be utilized. In such case, an email, SMS/text and/or phone communication may be used to request authentication by a challenge/response or other similar system.

One or more of the tests may be applied. If a knowledge based quiz test is indicated as an additional authentication test indicated by an additional authentication level, then a knowledge based quiz 266 may be used. The number of questions presented, and the number of correct answers required for a passing grade may be set by the policies and business rules. If the generally harder to answer out of wallet test is indicated, then test 264 is utilized to request answers to questions that you would not find in a user's wallet.

If the user receives a failing grade, authentication is denied and processed accordingly in step 272. The case management step 280 is used to deny access and log appropriate data such as user historical data. User historical data and behavior data 282 may also be collected from other parts of the system. If the use receives a passing grade, the user is authenticated and the fact that that level has been passed at that time is logged.

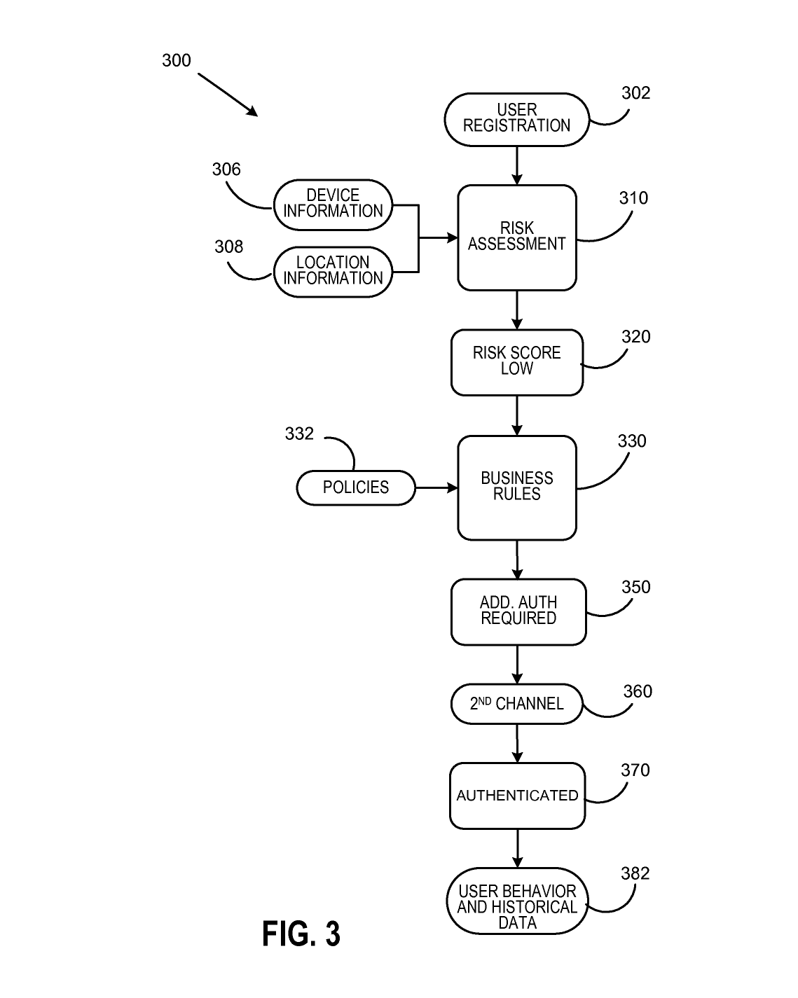

In order to provide such knowledge based test systems, a third party ID verification services provider such as ACXIOM is utilized. The third party provider utilizes public and private datasets to return knowledge based and out of wallet questions to the consumer for response when appropriate. In certain cases, it is important to have a diverse dataset in order to prevent fraudsters from simply purchasing a consumer's public record on the internet or dumpster diving. FIGS. 3-5 below present three typical use cases which build on each other to convey the approach of the illustrative embodiment.

Referring to FIG. 3, a flowchart diagram of a process 300 for providing efficient user authentication according to an illustrative embodiment of the present application is shown. For example, a use case showing a new user registration, wherein the new user does not require sensitive information is provided.

User Bob Smith visits the VOLLY portal, likes what he sees, and decides he wants to register for VOLLY. The system facilitates a registration which is quick and easy to lower the barriers to entry—which means no identity verification at this point. Bob just wants to get access to the site/sites, view some of the non-sensitive offers, coupons and so forth and has not yet decided to add any vendors, providers or mailers that would require access to sensitive information. Similarly, Bob Smith does not want to add payments functionality at this time. Accordingly, this is a no-risk new user registration transaction.

Here, Bob Smith is the new user requesting registration in step 302. The system may optionally use device information 306 and location information 308 to determine a risk level such as the user is using a US English version of Windows with an IP address in Connecticut. In step 310 the risk assessment runs and provides a risk score of low or no-risk in step 320. The risk assessment input includes that the transaction type is a new user registration and wherein no sensitive content is requested. The IP address and Country of Origin rules are checked. Furthermore, the user client device velocity may be checked.

The business rules are applied in 330 using the default VOLLY system new user registration transaction type policies in 332 to indicate that no additional authentication is required. Here, if a new user transaction does not request sensitive information, the policy provides for authentication. An alternative policy that may be applied requires a fast, no-cost step such as email verification. Bob Smith is authenticated in step 370, he is registered with a new user ID and login credentials. The system begins logging historical and behavioral data in step 382.

Optionally, in step 350 a no-cost level of authentication is provided such as the 2^{nd} channel email communication authentication 360 whereby Bob Smith receives an email at his stated email address and must select a return hyperlink in that email. If the email is verified, then Bob Smith is registered and provided a user name and login credentials. The system begins logging historical and behavioral data in step 382.

The goal is to quickly enable access to deals, coupons and other non-secure features. This is important because it provides a better customer experience and is speedy because this sub-process does not incur the latency of interfacing with the third-party knowledge based question vendors.

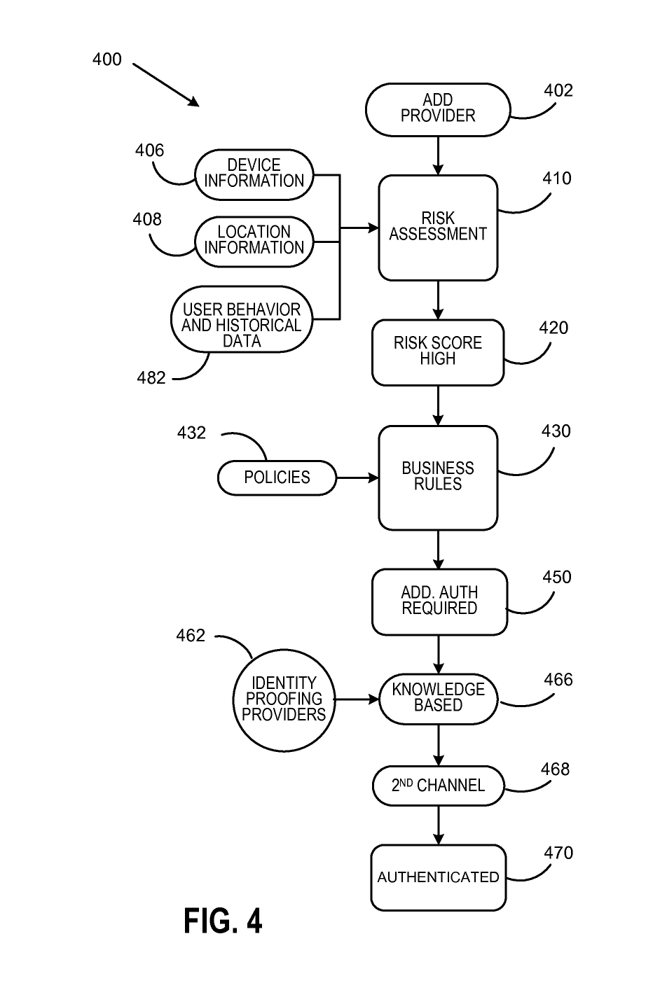

Referring to FIG. 4, a flowchart diagram of a process 400 for providing efficient user authentication according to an illustrative embodiment of the present application is shown. For example, a use case showing an add provider transaction for an existing user is provided.

Bob is now a registered VOLLY consumer and decides he wants to add his first provider (mailer). As soon as he initiates the add provider process, the system identifies this as a high risk transaction and that Bob has not yet gone through the identity verification process. The system now presents Bob with a series of questions (generated by the third party IDV partners) that deal with Bob's address history, telephone history, relationships, licenses, property records, etc. Bob responds to these questions, some after scratching his head for a few moments to recall, and passes the knowledge based quiz. The system has now verified Bob's identity for the purposes of adding providers and will not quiz him again unless there is significant change to the account (i.e., change of address) or a specific provider requirement.

Here, Bob Smith is the returning user who has previously registered with a no-authentication limited account. He is now requesting to add a provider (mailer) for the first time. He submits the required information such as name, address and account number for the provider. The system then provides a full identification verification process to ensure proper delivery. In step 402, Bob Smith requests to add a provider. The system may optionally use any of device information 406, location information 408 and feedback user behavior and historical data 482 to determine a risk level such as the user is using a US English version of Windows with an IP address in Connecticut. In step 410 the risk assessment runs and provides a risk score of medium or high risk in step 420. The risk assessment input includes that the transaction type is a limited user requesting sensitive content (add a provider). The IP address and Country of Origin rules are checked. Furthermore, the user client device signature and velocity may be checked. Historical behavior may be checked.

The business rules are applied in 430 using the default VOLLY system add a provider transaction type policies and/or any additional or substitute requirements of the provider/brand in 432 to indicate that additional authentication is required in step 450. Here, a knowledge based quiz KBA 466 is required due at least in part to the risk associated with the transaction type and the third party quiz provider 462 is utilized. An alternative policy that may be applied requires an additional, fast, no-cost step such as email verification 468, even if previously performed.

If Bob Smith passes the quiz, is authenticated in step 470, and is provided access to the new provider. The system begins logging historical and behavioral data in step 482. Here, the quiz may include 5 questions and may require 4 correct answers. The passing grade requirements may be set by default or vendor specific policy. The KBA quiz presented to the user is based upon one or more of public, private and proprietary records. The goal is to reasonably quickly enable access to sensitive information while maintaining appropriate security. Furthermore, if Bob Smith requests a transaction of the same or less risk, depending on default or override vendor policy associated with the new transaction, the prior authentication may be accepted, thereby obviating the need for a costly and time consuming additional knowledge based quiz.

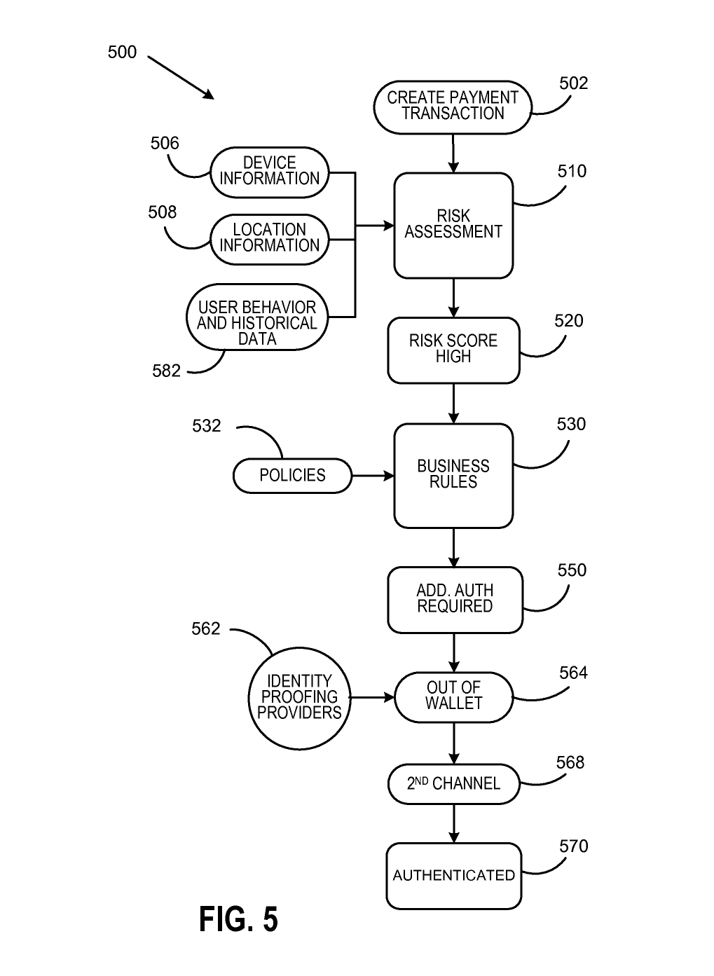

Referring to FIG. 5, a flowchart diagram of a process 500 for providing efficient user authentication according to an illustrative embodiment of the present application is shown. For example, a use case showing a higher risk activity such as creating a payment transaction is provided.

Bob is now a happy VOLLY user, having registered and added his providers. He has now managed to add five of his accounts to his digital mailbox and enjoys being paper-free for these billers. Now Bob wants to pay one of his bills through VOLLY. Bob goes to add a payment method and at this time the system identifies this as a higher risk transaction. The system then presents Bob with an out of wallet question test to verify Bob's identity for the session (beyond username and password). In this case we ask Bob to identify which street he once lived on, Bob selects “Elk Rd” and is successfully verified. He can now add his payment method(s).

Here, Bob Smith is the returning user who has previously fully identified with an additional authentication test (second level risk). He is now requesting to pay a bill, which is considered a higher risk (third level risk) transaction. The system checks that Bob has setup a payment method that has been accepted. The system then obtains Bob's payment request information. Bob submits the required information. The system then provides an additional authentication at the third level. In step 502, Bob Smith requests to process a payment transaction. The system may optionally use any of device information 506, location information 508 and feedback user behavior and historical data 582 to determine a risk level such as the user is using a US English version of Windows with an IP address in Connecticut. In step 510 the risk assessment runs and provides a risk score of high risk in step 520. The risk assessment input includes that the transaction type is a limited user requesting sensitive content (add a provider). The IP address and Country of Origin rules are checked. Furthermore, the user client device signature and velocity may be checked. Historical behavior may be checked. The transaction amount requested may be checked and the risk adjusted accordingly.

The business rules are applied in 530 using the default VOLLY system add a provider transaction type policies and/or any additional or substitute requirements of the provider/brand in 532 to indicate that additional third level authentication is required in step 550. Here, an out of wallet quiz 564 is required due at least in part to the risk associated with the transaction type and the third party quiz provider 562 is utilized. An alternative policy that may be applied requires an additional, fast, no-cost step such as email verification 568, even if previously performed.

If Bob Smith passes the quiz, is authenticated in step 570, and is provided access to process the payment transaction. Here, the quiz may include a number of questions and required correct answers set by policies 532. The goal is to reasonably quickly enable access to sensitive information while maintaining appropriate security.

Several additional embodiments are described herein. In one illustrative system, a computer system for processing user authentication data received over an electronic communications network for a user of a client-server computing system includes a processor operatively connected to a memory, the memory comprising instructions to cause the processor to execute instructions. The executed instructions including: receiving user information from the user over the electronic communications network from a client computer, obtaining transaction data associated with a transaction requested by the user, determining a risk value associated with the transaction, if the risk value is a first level of risk, then authenticating the user without providing an additional authentication test, if the risk value is a second level of risk, then obtaining a first additional authentication level associated with the transaction, and determining if the user has previously met at the first additional authentication level, if the risk value is the second level of risk, and the user has previously met the first additional authentication level, then authenticating the user without providing an additional authentication test, and if the risk value is the second level of risk, and the user has not previously met the first additional authentication level, then providing the user with a first additional authentication test, and authenticating the user only if the user passes the first additional authentication test.

In additional embodiments, the first additional authentication test includes a knowledge based quiz and/or an email verification test. In additional embodiments, determining a risk value associated with the transaction includes utilizing a transaction type risk value and a user information risk value. In yet additional embodiments, the processor to execute instructions including: if the risk value is a third level of risk, then obtaining a second additional authentication level associated with the transaction, and determining if the user has previously met the first additional authentication level, if the risk value is the third level of risk, and the user has previously met at the first additional authentication level, then authenticating the user without providing an additional authentication test, and if the risk value is a second level of risk, and the user has not previously met at the first additional authentication level, then providing the user with a first additional authentication test, and authenticating the user only if the user passes the first additional authentication test.

In yet additional embodiments, the second additional authentication test includes an out-of-wallet knowledge-based quiz, the transaction involves a particular provider having a particular provider identifier and the transaction has an associated transaction type, and obtaining a first additional authentication level associated with the transaction includes querying an authentication level policy database using the particular provider identifier and the transaction type.

In another embodiment, the first additional authentication test includes a knowledge based quiz having a first number of questions, whereby the user passes the first additional authentication test by answering an acceptable number of the first number of questions correctly, and the acceptable number is determined by querying the authentication level policy database using the particular provider identifier and the transaction type.

In an illustrative computer implemented method embodiment, a method for registering a new user of a client-server computing system over an electronic communications network includes obtaining use data from the user relating to an intended use of the client-server computing system, determining if the use data indicates access to sensitive content, if the use data does indicate access to sensitive content, then performing an identity verification process, if the use data does not indicate access to sensitive content, then registering a new user account without performing the identity verification process, and providing access to the user for a plurality of transactions that do not require access to sensitive content.

In another embodiment, the method includes obtaining and storing user behavioral profile data and user device data using the computer while providing access to the user for a plurality of transactions that do not require access to sensitive content, obtaining a request from the user for a transaction that indicates access to sensitive content, and performing the identity verification process at least partially based upon at least one of the stored user behavioral profile data and user device data.

In an illustrative system for processing user authentication data for a client-server computing system for serving a plurality of users and a plurality of vendors, the system includes: a processor operatively connected to a memory, the memory comprising instructions to cause the processor to execute instructions. The instructions including obtaining and storing user authentication parameters from a first vendor, wherein the user authentication parameters include at least a first transaction type profile having a first transaction risk level and a second transaction type profile having a second transaction risk level, obtaining and storing user authentication parameters from a second vendor, wherein the user authentication parameters include at least a first transaction type profile having a first transaction risk level and a third transaction type profile having a third transaction risk level, wherein the third transaction risk level is relatively higher than the second transaction risk level and the second transaction risk level is relatively higher than the first transaction risk level, obtaining transaction data associated with a transaction requested by a first user, the transaction associated with the first vendor, determining a transaction risk level associated with the transaction data, and processing authentication of the first user using the determined transaction risk level and the user authentication parameters.

In an alternative embodiment, the processor to execute instructions including: if the transaction data indicates the second transaction risk level, then determining if the first user has previously met the second or third transaction risk level in a transaction with any of the plurality of vendors, if the first user has previously met the second or third transaction risk level in a transaction with any of the plurality of vendors, then authenticating the first user without providing an additional authentication test, and if the user has not previously met the second or third transaction risk level in a transaction with any of the plurality of vendors, then providing the first user with a second additional authentication test based at least partly on user authentication parameters associated with the second vendor and the second transaction risk level, and authenticating the first user only if the user passes the second additional authentication test.

In another alternative, the second additional authentication test includes a knowledge based quiz, and the authentication parameters associated with the second vendor and the second transaction risk level include a number of correct questions required to pass the second additional authentication test. In another alternative, the second additional authentication test includes an email verification test. In another, determining that the transaction data indicates the second transaction risk level includes utilizing a transaction type risk value and a user information risk value.

In yet another embodiment, the processor to execute instructions including: if the transaction risk value is a first level of risk, then authenticating the user without providing an additional authentication test. In yet another embodiment, third transaction risk level is associated with a third additional authentication test including an out-of-wallet knowledge-based quiz. In another embodiment, the determined transaction risk level is at least partially based upon at least one of first user behavioral profile data and first user device data.

The ID Authentication portion of the system introduces the additional security feature of matching user client device characteristics, location, and consumer usage history for increased security. At the brand level, VOLLY is designed and positioned as the source of truth for the consumer's identity and mediates that relationship between the brand and the consumer. If brands trust VOLLY, and VOLLY trusts the consumer, a digital chain of trust is established which extends to both parties. The brand may still require additional information from the consumer (such as a unique identifier like account number, phone number, etc) to be sent with the name and address as part of the matching criteria sent to the brand, but VOLLY has verified the consumers identity prior to that information being sent and a document requested.

Each of the user client devices is a DELL laptop or tablet respectively and executes a WINDOWS 7 operating system and an INTERNET EXPLORER browser or a MOTOROLA device such as a DROID 3 or XYBOARD executing the ANDROID operating system or APPLE IPAD or IPHONE executing the iOS operating system. Each client device includes at least one processor, display, input such as a keyboard and mouse, RAM memory for data and instructions, disk memory, network and external storage connections. If the above mentioned cloud architectures are not used, the server may include a DELL POWEREDGE M1000E server, but other servers may be used including geographically dispersed and/or load balanced servers. Such servers include at least one processor, RAM memory for data and instructions, disk memory, network and external storage connections. Alternatively, an IBM POWER 795 Server or APACHE Web Server may be utilized. Here, the Internet is utilized for many of the network connections of the systems 100/300, but other networks including LAN, WAN, cellular, satellite and other wired and/or wired networks may be used for one or more of the interconnections shown. The databases storing user login information and user account information may be configured using an available relational database such as ORACLE 12i or MICROSOFT SQL server or APACHE CASSANDRA. Any or all of the databases may be resident in a single server or may be geographically distributed and/or load balanced. They may be retrieved in real time or near real time using networking such as web services connected to third party data providers. Many alternative configurations may be used including multiple servers and databases including a geographically distributed system. The processes described herein may be implemented in C++, Java, C# on a MICROSOFT WINDOWS 7 platform and utilize the ADOBE CQ5 web content management system. Alternatively, PHP code may be used with open source systems and APACHE web server with APACHE CASSANDRA databases. Other alternatives such as the JOOMLA content management system and MYSQL databases may be utilized.

Although the invention has been described with respect to particular illustrative embodiments thereof, it will be understood by those skilled in the art that the foregoing and various other changes, omissions and deviations in the form and detail thereof may be made without departing from the scope of this invention.

What is claimed is:

1. A computer system for processing user authentication data received over an electronic communications network for a user of a client-server computing system comprising:
a processor operatively connected to a memory, the memory comprising instructions to cause the processor to execute instructions including,
receiving user information from the user over the electronic communications network from a client computer;
obtaining transaction data associated with a transaction requested by the user;
determining a risk value associated with the transaction;
if the risk value is a first level of risk, then authenticating the user without providing an additional authentication test;
if the risk value is a second level of risk, then obtaining a first additional authentication level associated with the transaction, and determining if the user has previously met at the first additional authentication level;
if the risk value is the second level of risk, and the user has previously met the first additional authentication level, then authenticating the user without providing an additional authentication test; and
if the risk value is the second level of risk, and the user has not previously met the first additional authentication level, then providing the user with a first additional authentication test, and authenticating the user only if the user passes the first additional authentication test.

2. The system of claim 1, wherein,
the first additional authentication test includes a knowledge based quiz.

3. The system of claim 1, wherein,
the first additional authentication test includes an email verification test.

4. The system of claim 1, wherein,
determining a risk value associated with the transaction includes utilizing a transaction type risk value and a user information risk value.

5. The system of claim 1, further comprising:
the processor to execute instructions including:
if the risk value is a third level of risk, then obtaining a second additional authentication level associated with the transaction, and determining if the user has previously met the first additional authentication level;
if the risk value is the third level of risk, and the user has previously met at the first additional authentication level, then authenticating the user without providing an additional authentication test; and
if the risk value is a second level of risk, and the user has not previously met at the first additional authentication level, then providing the user with a first additional authentication test, and authenticating the user only if the user passes the first additional authentication test.

6. The system of claim 5, wherein,
the second additional authentication test includes an out-of-wallet knowledge-based quiz.

7. The system of claim 1, wherein,
the transaction involves a particular provider having a particular provider identifier and the transaction has an associated transaction type; and
obtaining a first additional authentication level associated with the transaction includes querying an authentication level policy database using the particular provider identifier and the transaction type.

8. The system of claim 7, wherein,
the first additional authentication test includes a knowledge based quiz having a first number of questions;
whereby the user passes the first additional authentication test by answering an acceptable number of the first number of questions correctly; and
the acceptable number is determined by querying the authentication level policy database using the particular provider identifier and the transaction type.

9. A computer implemented method for registering a new user of a client-server computing system over an electronic communications network comprising:
obtaining use data from the user relating to an intended use of the client-server computing system;
determining if the use data indicates access to sensitive content;
if the use data does indicate access to sensitive content, then performing an identity verification process;
if the use data does not indicate access to sensitive content, then registering a new user account without performing the identity verification process; and
providing access to the user for a plurality of transactions that do not require access to sensitive content.

10. The method of claim 9, further comprising:
obtaining and storing user behavioral profile data and user device data using the computer while providing access to the user for a plurality of transactions that do not require access to sensitive content;
obtaining a request from the user for a transaction that indicates access to sensitive content; and
performing the identity verification process at least partially based upon at least one of the stored user behavioral profile data and user device data.

11. A computer system for processing user authentication data for a client-server computing system for serving a plurality of users and a plurality of vendors comprising:
a processor operatively connected to a memory, the memory comprising instructions to cause the processor to execute instructions including,
obtaining and storing user authentication parameters from a first vendor, wherein the user authentication parameters include at least a first transaction type profile having a first transaction risk level and a second transaction type profile having a second transaction risk level;
obtaining and storing user authentication parameters from a second vendor, wherein the user authentication parameters include at least a first transaction type profile having a first transaction risk level and a third transaction type profile having a third transaction risk level;
wherein the third transaction risk level is relatively higher than the second transaction risk level and the second transaction risk level is relatively higher than the first transaction risk level;
obtaining transaction data associated with a transaction requested by a first user, the transaction associated with the first vendor;
determining a transaction risk level associated with the transaction data; and
processing authentication of the first user using the determined transaction risk level and the user authentication parameters.

12. The system of claim 11, further comprising:
the processor to execute instructions including:
if the transaction data indicates the second transaction risk level, then determining if the first user has previously met the second or third transaction risk level in a transaction with any of the plurality of vendors;
if the first user has previously met the second or third transaction risk level in a transaction with any of the plurality of vendors, then authenticating the first user without providing an additional authentication test;
if the user has not previously met the second or third transaction risk level in a transaction with any of the plurality of vendors, then providing the first user with a second additional authentication test based at least partly on user authentication parameters associated with the second vendor and the second transaction risk level, and authenticating the first user only if the user passes the second additional authentication test.

13. The system of claim 12, wherein,
the second additional authentication test includes a knowledge based quiz, and
the authentication parameters associated with the second vendor and the second transaction risk level include a number of correct questions required to pass the second additional authentication test.

14. The system of claim 12, wherein,
the second additional authentication test includes an email verification test.

15. The system of claim 12, wherein,
determining that the transaction data indicates the second transaction risk level includes utilizing a transaction type risk value and a user information risk value.

16. The system of claim 11, further comprising:
the processor to execute instructions including:
if the transaction risk value is a the first level of risk, then authenticating the user without providing an additional authentication test.

17. The system of claim 11, wherein,
third transaction risk level is associated with a third additional authentication test including an out-of-wallet knowledge-based quiz.

18. The system of claim 11, wherein,
the determined transaction risk level is at least partially based upon at least one of first user behavioral profile data and first user device data.
